(19) United States
(12) Patent Application Publication
(10) Pub. No.: US 2020/0024165 A1
(43) Pub. Date: Jan. 23, 2020

(54) A METHOD FOR DEGRADING 5-CHLORO-2-METHYL-4-ISOTHIAZOLIN-3-ONE

(71) Applicant: DOW GLOBAL TECHNOLOGIES LLC, Midland, MI (US)

(72) Inventors: Patrick T. Felder, Horgan (CH); Emmanuelle Christine Yvon, Horgen (CH)

(21) Appl. No.: 16/334,866

(22) PCT Filed: Oct. 9, 2017
(86) PCT No.: PCT/US2017/055686

§ 371 Date: Mar. 20, 2019

Related U.S. Application Data
(60) Provisional application No. 62/415,275, filed on Oct. 31, 2016.

(51) Int. Cl. C02F 1/68; C09D 7/63; C08K 5/36

(52) U.S. Cl. CPC C02F 1/68; C02F 2101/38; C08K 5/36; C09D 7/63

(57) ABSTRACT

A method for degrading 5-chloro-2-methyl-4-isothiazolin-3-one in a liquid composition using dithio-2,2′-bis(benzmethylamide).

The present invention relates to a method for degrading 5-chloro-2-methyl-4-isothiazolin-3-one from in-can products to minimize user contact.

A variety of antimicrobial compounds is used to control growth of microorganisms in products. In some cases, chlorinated isothiazolin-3-ones are used to provide control of microorganisms in a particular end use environment. However, chlorinated isothiazolone-3-ones can act as sensitizers and are sometimes regarded as undesirable components in products, especially for in-can preservation products, including but not limited to preservation products for paints and coatings and household, industrial, and institutional products. A method for degrading 5-chloro-2-methyl-4-isothiazolin-3-one would be desirable.

Methods are known for degrading isothiazolin-3-ones. For example, U.S. Pat. No. 5,641,411 discloses a method for detoxifying industrial effluents containing isothiazolin-3-ones by contacting the effluents with a water soluble organic thiol compound. However, there is a need for a sustainable and more environmentally friendly method for treating products in situ to reduce levels of isothiazolin-3-ones without introducing other objectionable compounds into the product. The problem addressed by this invention is to provide such a method for in situ reduction of antimicrobial compounds.

### STATEMENT OF THE INVENTION

A method is provided for degrading 5-chloro-2-methyl-4-isothiazolin-3-one comprising contacting 5-chloro-2-methyl-4-isothiazolin-3-one with dithio-2,2′-bis(benzmethylamide) wherein after the 5-chloro-2-methyl-4-isothiazolin-3-one is contacted with dithio-2,2′-bis(benzmethylamide), 5-chloro-2-methyl-4-isothiazolin-3-one is present in an amount from 0 to 1 ppm.

### DETAILED DESCRIPTION OF THE INVENTION

Unless otherwise specified, temperatures are in degrees centigrade (° C.), references to percentages are by weight (wt. %) and references to “ppm” are in parts per million by weight (weight/weight) of active ingredient (antimicrobial compound). Weights and functionality of resin are on a dry basis, unless otherwise specified. All numerical range endpoints are inclusive and combinable. “CMIT” is 5-chloro-2-methyl-4-isothiazolin-3-one (CAS: 2617-55-4) or a blend of (5-chloro-2-methyl-4-isothiazolin-3-one (“CMI”) with “MI” (2-Methyl-1,2-thiazol-3(2H)-one) (CAS: 2617-55-4/2682-20-4)). “DTBMA” is dithio-2,2′-bis(benzmethylamide) (CAS: 2527-58-4). A liquid composition is one which comprises a continuous liquid phase at 25° C. The liquid phase may be aqueous, an oil-in-water emulsion, or oil-based, preferably aqueous. The composition may also contain insoluble solids, which may be dispersed, suspended or emulsified.

As used herein, “degrading 5-chloro-2-methyl-4-isothiazolone” means that the 5-chloro-2-methyl-4-isothiazolone within a period of up to 1 month, alternatively over a period of 2 weeks, further alternatively over a period of 1 week, further alternatively within 24 hours, further alternatively within 12 hours, further alternatively within 6 hours, further alternatively within 2 hours, further alternatively within 1 hour is irreversibly decomposed or degraded, so that after this period, the content of 5-chloro-2-methyl-4-isothiazolone, based on the product is in the range from 0 to 1.0 ppm, alternatively 0 to 0.5 ppm, further alternatively in the range of 0 to 0.1 ppm.

As used herein, the following terms have the designated definitions, unless the context clearly indicates otherwise. The term “antimicrobial compound” or “biocide” refers to a compound capable of inhibiting the growth of or controlling the growth of microorganisms at a locus; antimicrobial compounds include bactericides, bacteristats, fungicides, fungistats, algaecides and algistats, depending on the dose level applied, system conditions and the level of microbial control desired. The term “microorganism” includes, for example, fungi (such as yeast and mold), bacteria and algae.

In the present invention the method for degrading CMIT comprises contacting CMIT with DTBMA wherein after the CMIT is contacted with DTBMA, CMIT is present in an amount from 0 to 1.0 ppm. The CMIT is contacted with DTBMA by conventional means known by those of ordinary skill in the art. The CMIT and the DTBMA may be added to a liquid composition. The two compounds may be added sequentially or simultaneously.

Preferably, prior to degrading CMIT, the liquid composition contains from 1 ppm to 100 ppm total of CMIT, preferably at least 5 ppm, preferably at least 10 ppm, preferably at least 15 ppm, preferably no more than 75 ppm, preferably no more than 60 ppm, preferably no more than 50 ppm, preferably no more than 40 ppm, preferably no more than 30 ppm. Preferably, prior to degrading CMIT, the liquid composition contains from 1 ppm to 500 ppm total of DTBMA, preferably at least 25 ppm, preferably at least 75 ppm, preferably at least 100 ppm, preferably no more than 400 ppm, preferably no more than 300 ppm, preferably no more than 250 ppm, preferably no more than 200 ppm, preferably no more than 150 ppm. Prior to degrading CMIT with DTBMA, CMIT may be present alone (as CMIT alone or as a blend with MIT) combination with other known biocides. Preferably the CMIT is present alone. Additionally, the liquid composition may comprise additional known biocides. Preferably no other biocides are present in the liquid composition.

The liquid composition in the present invention may include, for example: cooling tower water; mineral slurries; wastewater; ballast water; pulp and paper processing fluids; emulsions; dispersions; paints; latices; construction adhesives, such as ceramic adhesives, carpet backing adhesives, and laminating adhesives; industrial or consumer adhesives; photographic chemicals; printing fluids; household products, such as bathroom and kitchen cleaners; personal care products such as cosmetics, toiletries, shampoos, and liquid soaps and detergents; industrial cleaners; floor polishes; laundry rinse water; metalworking fluids; conveyor lubricants; hydraulic fluids; petroleum processing fluids; fuel; oilfield fluids, such as injection water, fracture fluids, and drilling muds; and water from pools and spas. Preferably, the method of the present invention is used to reduce CMIT levels in paints and coatings and personal care products, i.e., those intended to be applied directly to human or animal skin. In personal care compositions, other ingredients may include, e.g., UV radiation-absorbing agents, surfactants, rheology modifiers or thickeners, fragrances, moisturizers, humectants, emollients, conditioning agents, emulsifiers, antistatic aids, pigments, dyes, tints, colorants, antioxidants, reducing agents and oxidizing agents.

Preferably, the pH of the liquid composition, measured at 25° C., is from 3.0 to 10, preferably from 4.0 to 9.0, preferably from 5.0 to 9.0, preferably from 7 to 9. Preferably, the liquid composition prior to degrading CMIT has a temperature from 10° C. to 60° C., preferably from 15° C. to 40° C., preferably from 18° C. to 30° C.

### EXAMPLES

Treatment of Aqueous Liquid Compositions

The aqueous liquid compositions tests were aqueous paints or aqueous, pH-adjusted solutions with or without buffer. The former contained normally typical levels of in-can preservatives (30-200 ppm) ensuring their integrity, i.e. avoided quick degradation by microbial infestation of the biocidal actives to be added later. The aqueous liquid compositions “as are” (without additional biocidal actives) acted as control in the UHPLC analyses described below.

CMIT/MIT(3:1) and DTBMA or MBIT—with and without co-biocides (additionally to the ones already present in the pre-treated aqueous liquid compositions)—were added to the aqueous liquid compositions such that each biocidal active reached a specified concentration, typically between 20-200 ppm, depending on active. The biocidal products used were:

| | |
|---|---|
| KATHON ™ LXE | 1.6% CMI/MI (3:1), liquid |
| ROCIMA ™ 556 or | 10% DTBMA or 25% DTBMA aq. dispersion, |
| DENSIL P: | respectively |
| ROCIMA ™ 518 | 7.5% BIT, 3.6% DTBMA, aqueous dispersion |
| Experimental | 25% MBIT, liquid |
| product MB25 | |
| ROCIMA ™ GT | 1.05% CIT/MIT, 3.75% DDAC, 7.4% EDDM |

“BIT” is 1,2-benzisothiazol-3(2H)-one—CAS 2634-33-5.

“MBIT” is 2-methyl-1,2-benzisothiazol-3(2H)-one—CAS 2527-66-4.

“DDAC” is Didecyldimethylammonium chloride

“EDDM” is (Ethylenedioxy)dimethanol

ROCIMA™ and KATHON™ products are commercially available from The Dow Chemical Company, Midland, Mich.

HPLC Method

The analytical method applied was based on reversed-phase UHPLC using biocidal standards, a C18 column (Zorbax eclipse, 2.1*100 mm-1.8 micron with pre-column Zorbax eclipse, 2.1*5 mm-1.8 micron) and UV DAD detection.

The biocidal standards were prepared from 1000 ppm AI Standard Stock Solutions comprising methanol-water (50:50) or DMSO as solvent matrix by dilution in methanol-water (50:50) to 100 ppm or 20 ppm (ZPT), respectively.

1 ml of these biocide standard solutions were transferred and filtered through a 0.2 μm filter into an autosampler vial.

The test solutions were prepared by weighing 1 g of the biocidal test samples into a 50 ml vial, adding 9 ml of MeOH/H2O 50:50, followed by sonication for 30 minutes. After addition of 0.1 ml of acetic acid the mixture was centrifuged at 4000 rpm for 4 minutes.

1 ml of these test solutions were transferred and filtered through a 0.2 μm filter into an autosampler vial.

HPLC Chromatographic Parameters:

| Column temperature: | | 45° C. |
|---|---|---|
| Flow rate: | | 0.8 ml/minute |
| Solvents: | Reservoir A: | H3PO4, 0.01% in water |
| | Reservoir B: | Acetonitrile |

| Mobile Phase | | | |
|---|---|---|---|
| Gradient: | Minutes | A | B |
| | 0 | 100% | 0% |
| | 2 | 100% | 0% |
| | 10 | 50% | 50% |
| | 11 | 0% | 100% |
| | 14 | 0% | 100% |
| | 15 | 100% | 0% |
| | 18 | 100% | 0% |

| | |
|---|---|
| End time: | 18 minutes |
| Injection Volume: | 5 μl |
| Wave lengths: | 280 nm for MIT, CMIT |
| | 315 nm for BIT, n-MBIT, |
| Retention times | all analyzed biocidal actives between 1 and 14 |
| | minutes |

Timing

For time zero, the analytical solutions were prepared within 1-2 hours after treating the aqueous liquid compositions with biocidal actives such as CMI/MI and/or DTBMA.

Analysis of the prepared solutions was completed within the shortest possible time.

The preparations and analysis of the standard and test solutions were executed at defined time intervals between 1 hour and 1 month.

Analysis

The biocide concentrations in the test samples were calculated from peak areas of standard and test sample, taking into account the concentration of standard, the sample weight and the dilution factor (10×).

Paint A, pH 9: CMI degradation in presence of DTBMA, using ROCIMA 518 product (DTBMA/BIT)

| | | | | | Results in | |
|---|---|---|---|---|---|---|
| | | | | Time of | ppm | |
| Example # | Sample | Addition | pH | measurement | CMIT | MIT |
| | A | none (control) | pH 9 | n/a | 0.8 | 0.7 |
| 1 | A | 0.14% ROCIMA GT | | time zero, | 12.4 | 4.6 |
| | | | | calculated | | |
| | | | | 1 week | 10.9 | 4.6 |
| 2 | A | 0.3% ROCIMA GT | | time zero, | 25.6 | 9.0 |
| | | | | calculated | | |
| | | | | 1 week | 20.6 | 8.6 |
| 3 | A | 0.3% ROCIMA 518 | | time zero, | 12.4 | 4.6 |
| | | (DTBMA/BIT) | | calculated | | |
| | | 0.14% ROCIMA GT | | 1 week | 0 | 4 |
| 4 | A | 0.3% ROCIMA 518 | | time zero, | 25.6 | 9.0 |
| | | (DTBMA/BIT) | | calculated | | |
| | | 0.3% ROCIMA GT | | 1 week | 0 | 11 |

Paint B, pH 8.2: CMI degradation in presence of DTBMA, using ROCIMA 556 product (DTBMA)

| | | | | | Results in | |
|---|---|---|---|---|---|---|
| | | | | Time of | ppm | |
| Example # | Sample | Addition | pH | measurement | CMIT | MIT |
| | B | none (control) | pH 8.2 | start | 0 | 31 |
| | | | | 1 h | 0 | 31 |
| | | | | 3 d | 0 | 31 |
| | | | | 1 week | 0 | 31 |
| 5 | B | KATHON LXE, 0.31% | | time zero, | 37 | 44 |
| | | | | calculated | | |
| | | | | 0.5 h | 46 | 46 |
| | | | | 1 h | 46 | 46 |
| | | | | 3 d | 44 | 46 |
| | | | | 1 week | 39 | 46 |
| 6 | B | KATHON LXE, 0.31% | | time zero, | 37 | 44 |
| | | ROCIMA 556 (DTBMA), | | calculated | | |
| | | 0.1% | | 0.5 h | 0 | 43 |
| | | | | 1 h | 0 | 44 |
| | | | | 3 d | 0 | 44 |
| | | | | 1 week | 0 | 43 |
| Comp 1 | B | KATHON LXE, 0.31% | | time zero, | 37 | 44 |
| | | Exp. Prod. MB25 (MBIT), | | calculated | | |
| | | 0.04% | | 0.5 h | 40 | 44 |
| | | | | 1 h | 41 | 45 |
| | | | | 3 d | 41 | 45 |
| | | | | 1 week | 36 | 45 |

Paint C, pH 7.2: CMI degradation in presence of DTBMA, using Densil P (DTBMA)

| | | | | | Results in | |
|---|---|---|---|---|---|---|
| | | | | Time of | ppm | |
| Example # | Sample | Addition | pH | measurement | CMIT | MIT |
| | C | none (control) | pH 7.2 | n/a | 3 | 2 |
| 7 | C | KATHON LXE, 0.2% | | time zero, | 27 | 10 |
| | | | | calculated | | |
| | | | | 0.5 h | 22 | 10 |
| | | | | 1 h | 22 | 10 |
| | | | | 2 h | 23 | 10 |
| | | | | 1 week | 23 | 11 |
| 8 | C | KATHON LXE, 0.2% | | time zero, | 27 | 10 |
| | | Densil P (DTBMA), 0.04% | | calculated | | |
| | | | | 0.5 h | 6 | 10 |
| | | | | 1 h | 0 | 10 |
| | | | | 2 h | 0 | 10 |
| | | | | 1 week | 0 | 11 |
| Comp 2 | C | KATHON LXE, 0.2% | | time zero, | 27 | 10 |
| | | Exp. Prod.MB25 (MBIT), | | calculated | | |
| | | 0.02% | | 0.5 h | 25 | 11 |
| | | | | 1 h | 24 | 11 |
| | | | | 2 h | 25 | 11 |
| | | | | 1 week | 24 | 11 |

Water, pH 7: CMI degradation in presence of DTBMA, using ROCIMA 518 product (DTBMA/BIT)

| | | | | | Result in | |
|---|---|---|---|---|---|---|
| | | | | Time of | ppm | |
| Example # | Sample | Addition | pH | measurement | CMIT | MIT |
| | D | none (control) | pH 7 | time zero, | 27 | 9 |
| | | | | calculated | | |
| 9 | D | ROCIMA GT, 0.33% | | 0.5 h | 23 | n.d. |
| | | ROCIMA 518 (DTBMA/BIT), | | 1.5 h | 20 | n.d. |
| | | 0.44% | | 18 h | 15 | n.d. |

Water/Polyglycol (80:20), pH 7: CMI degradation in presence of DTBMA, using ROCIMA 556 product (DTBMA)

| | | | | | Result in | |
|---|---|---|---|---|---|---|
| | | | | Time of | ppm | |
| Example # | Sample | Addition | pH | measurement | CMIT | MIT |
| | E | none (control) | pH 7 | n/a | n.d. | n.d. |
| 10 | E | KATHON LXE, 0.31% | | time zero, | 37 | 12 |
| | | | | calculated | | |
| | | | | 0.5 h | 42 | 13 |
| | | | | 1 h | 42 | 13 |
| | | | | 3 d | 43 | 13 |
| | | | | 1 week | 40 | 13 |
| 11 | E | KATHON LXE, 0.31% | | time zero, | 37 | 12 |
| | | ROCIMA 556 (DTBMA), | | calculated | | |
| | | 0.1% | | 0.5 h | 30 | 12 |
| | | | | 1 h | 20 | 12 |
| | | | | 3 d | 0 | 11 |
| | | | | 1 week | 0 | 11 |
| Comp 3 | E | KATHON LXE, 0.31% | | time zero, | 37 | 12 |
| | | Exp. Prod. MB25 (MBIT), | | calculated | | |
| | | 0.04% | | 0.5 h | 42 | 13 |
| | | | | 1 h | 42 | 13 |
| | | | | 3 d | 43 | 13 |
| | | | | 1 week | 40 | 13 |

Water/Polyglycol (80:20), pH 4: CMI degradation in presence of DTBMA, using ROCIMA 556 product (DTBMA)

| | | | | Time of | Result in ppm | |
|---|---|---|---|---|---|---|
| Example # | Sample | Addition | pH | measurement | CMIT | MIT |
| | F | none (control) | pH 4 | n/a | n.d. | n.d. |
| 12 | F | KATHON LXE, 0.31% | | time zero, | 37 | 12 |
| | | | | calculated | | |
| | | | | 0.5 h | 42 | 13 |
| | | | | 1 h | 42 | 13 |
| | | | | 3 d | 43 | 13 |
| | | | | 1 week | 40 | 13 |
| 13 | F | KATHON LXE, 0.31% | | time zero, | 37 | 12 |
| | | ROCIMA 556 (DTBMA), | | calculated | | |
| | | 0.1% | | 0.5 h | 38 | 13 |
| | | | | 1 h | 31 | 13 |
| | | | | 3 d | 0 | 13 |
| | | | | 1 week | 0 | 13 |
| Comp 4 | F | KATHON LXE, 0.31% | | time zero, | 37 | 12 |
| | | Exp. Prod. MB25 (MBIT), | | calculated | | |
| | | 0.04% | | 0.5 h | 43 | 13 |
| | | | | 1 h | 43 | 13 |
| | | | | 3 d | 43 | 13 |
| | | | | 1 week | 40 | 13 |

n.d.: not determined

1. A method for degrading 5-chloro-2-methyl-4-isothiazolin-3-one comprising contacting 5-chloro-2-methyl-4-isothiazolin-3-one with dithio-2,2′-bis(benzmethylamide) wherein after the 5-chloro-2-methyl-4-isothiazolin-3-one is contacted with dithio-2,2′-bis(benzmethylamide), 5-chloro-2-methyl-4-isothiazolin-3-one is present in an amount from 0 to 1.0 ppm.

2. The method of claim 1 wherein after the 5-chloro-2-methyl-4-isothiazolin-3-one is contacted with dithio-2,2′-bis(benzmethylamide), 5-chloro-2-methyl-4-isothiazolin-3-one is present from 0 to 0.1 ppm.

3. The method of claim 1 wherein 5-chloro-2-methyl-4-isothiazolin-3-one and dithio-2,2′-bis(benzmethylamide) are contacted in a liquid composition.

4. The method of claim 3 wherein the liquid composition is aqueous.

5. The method of claim 4 in which the liquid composition is cooling tower water; mineral slurries; wastewater; ballast water; pulp and paper processing fluids; emulsions; dispersions; paints; latices; construction adhesives, such as ceramic adhesives, carpet backing adhesives, and laminating adhesives; industrial or consumer adhesives; photographic chemicals; printing fluids; household products, such as bathroom and kitchen cleaners; personal care products such as cosmetics, toiletries, shampoos, and liquid soaps and detergents; industrial cleaners; floor polishes; laundry rinse water; metalworking fluids; conveyor lubricants; hydraulic fluids; petroleum processing fluids; fuel; oilfield fluids, such as injection water, fracture fluids, and drilling muds; and water from pools and spas.

6. The method of claim 4 wherein the pH of the liquid composition is from 3.0 to 10.

7. The method of claim 1 wherein the 5-chloro-2-methyl-4-isothiazolin-3-one is presented in a blend with 2-methyl-1,2-thiazol-3(2H)-one).

8. A coating product composition formed by the method of claim 1 wherein the coating product composition comprises dithio-2,2′-bis(benzmethylamide) and from 0 to 1.5 ppm 5-chloro-2-methyl-4-isothiazolin-3-one.

9. A household product composition formed by the method of claim 1 wherein the household product composition comprises dithio-2,2′-bis(benzmethylamide) and from 0 to 1.5 ppm 5-chloro-2-methyl-4-isothiazolin-3-one.
